(19) United States
(12) Patent Application Publication
(10) Pub. No.: US 2012/0218432 A1
(43) Pub. Date: Aug. 30, 2012

(54) RECURSIVE ADAPTIVE INTRA SMOOTHING FOR VIDEO CODING

(75) Inventors: Wei Liu, San Jose, CA (US); Mohammad Gharavi-Alkhansari, Santa Clara, CA (US); Ehsan Maani, San Jose, CA (US); Yoichi Yagasaki, Tokyo (JP)

(73) Assignee: SONY CORPORATION, Tokyo (JP)

(21) Appl. No.: 13/036,972

(22) Filed: Feb. 28, 2011

(51) Int. Cl. H04N 7/26; H04N 5/228; H04N 7/32

(52) U.S. Cl. 348/222.1; 375/240.12; 375/240.24; 375/240.13; 348/E05.031; 375/E07.243; 375/E07.226; 375/E07.026

(57) ABSTRACT

A recursive adaptive intra smoothing filter for intra-mode video coding is executed using one or more approaches including, but not limited to matrix multiplication, spatial filtering and frequency domain filtering. Matrix multiplication includes initially computing a prediction matrix Pₘ using training data. After coding a macroblock, Pₘ is updated for future macroblocks. In the case of applying spatial filtering, the shift invariance problem is reduced by imposing certain constraints on the matrix to be solved. In frequency domain filtering, a transform residual is minimized using DCT-domain filtering.

### FIELD OF THE INVENTION

The present invention relates to the field of image/video processing. More specifically, the present invention relates to recursive adaptive intra smoothing (RAIS) for video coding.

### BACKGROUND OF THE INVENTION

H.264/AVC is a relatively new international video coding standard. It considerably reduces the bit rate by approximately 30 to 70 percent when compared with previous video coding standards such as MPEG-4 Part 2 and H.263, while providing similar or better image quality.

The intra coding algorithm of H.264 exploits the spatial and spectral correlation present in an image. Intra prediction removes spatial redundancy between adjacent blocks by predicting one block from its spatially adjacent causal neighbors. A choice of coarse and fine intra prediction is allowed on a block-by-block basis. There are two types of prediction modes for the luminance samples. The 4×4 Intra mode predicts each 4×4 block independently within a macroblock, and the 16×16 Intra mode predicts a 16×16 macroblock as a whole unit. For 4×4 Intra mode, nine prediction modes are available for the encoding procedure, among which one represents a plain DC prediction, and the remaining ones operate as directional predictors distributed along eight different angles. Intra mode 16×16 is suitable for smooth image areas, where four directional prediction modes are provided as well as the separate intra prediction mode for the chrominance samples of a macroblock. In H.264 high profile, 8×8 intra prediction is introduced in addition to 4×4 and 16×16 intra prediction.

H.264 achieves excellent compression performance and complexity characteristics in the intra mode even when compared against the standard image codecs (JPEG and JPEG2000). In recent years, extended works have been developed to further improve the performance of intra prediction. Some authors introduced intramotion compensated prediction of macroblocks. Block size and accuracy adaptation are able to be brought into the intra block-matching scheme to further improve the prediction results. In such a manner, the position of reference block is coded into the bit stream. Thus, a significant amount of extra side information would affect the performance significantly. To reduce this overhead information, special processing techniques have been developed and result in a big change of intra coding structure in the H.264/AVC standard. In some references, a block-matching algorithm (BMA) is utilized to substitute for H.264 DC intra prediction mode with no need to code side information. However, prediction performance would be degraded if previously reconstructed pixels are used for the matching procedure. Also, improved lossless intra coding methods are proposed to substitute for horizontal, vertical, diagonal-down-left (mode 3) and diagonal-down-right (mode 4) of H.264/AVC. They employ a samplewise differential pulse code modulation (DPCM) method to conduct prediction of pixels in a target block. Yet these kinds of methods are only able to be used in lossless mode.

From the above-mentioned analysis, current-enhanced intra coding methods still have problems, namely, either changing the coding structures significantly, having limited usage or less gain.

### SUMMARY OF THE INVENTION

A recursive adaptive intra smoothing filter for intra-mode video coding is executed using one or more approaches including, but not limited to matrix multiplication, spatial filtering and frequency domain filtering. Matrix multiplication includes initially computing a prediction matrix Pₘ (derived using offline training data). After coding a macroblock, Pₘ is updated for future macroblocks. In the case of applying spatial filtering, the shift invariance problem is reduced by imposing certain constraints on the matrix to be solved. In frequency domain filtering, a transform residual is minimized using DCT-domain filtering.

In one aspect, a method of filtering a video programmed in a memory in a device comprises calculating a prediction matrix using a training data set and recursively re-calculating the prediction matrix using a previous prediction matrix and prediction data of a current macroblock using neighboring pixels. The training data set is an offline training data set. The prediction matrix is computed using a cross-correlation matrix and an auto-correlation matrix. The filtering is applied to video coding. The coding comprises intra coding. The method further comprises implementing spatial filtering. Spatial filtering comprises restricting allowable values of the prediction matrix. A filter is restricted to have a unity DC gain, and/or a linear phase response. The filter is shift-invariant, and coefficients are chosen so that the L₂-norm prediction residual is minimized based on past statistics. Filtering is not implemented if the neighboring pixels are across an edge. The method further comprises implementing Discrete Cosine Transform-domain filtering. Implementing discrete cosine transform-domain filtering comprises taking a discrete cosine transform of a block using a set of predictors resulting in transform coefficients, applying a weighting to the transform coefficients and taking an inverse discrete cosine transform to generate new predictors. The method further comprises taking the discrete cosine transform of neighboring pixels of the block for prediction. The method further comprises taking the discrete cosine transform utilizes a line of pixels from an above neighboring block and a same line of pixels from a left neighboring block. Applying the weighting includes weighting factors initially derived from offline training and updating based on previous reconstructed pixels. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray® writer/player, a television and a home entertainment system.

In another aspect, a method of filtering a video programmed in a memory in a device comprises implementing a first filter for filtering a first row/column of a block of the video and implementing one or more additional filters for filtering additional rows/columns of the block of the video. The first row/column is nearest to predictor pixels and the additional rows/columns are further from the predictor pixels. The first filter is weaker than the one or more additional filters. The one or more additional filters are each as strong or are progressively stronger in low-pass as a distance from predictor pixels increases. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray® writer/player, a television and a home entertainment system.

In another aspect, a system for filtering a video programmed in a memory in a device comprises a matrix multiplication module for implementing matrix multiplication on a block of the video, a spatial filtering module for applying spatial filtering to the matrix multiplication and a discrete cosine transform-domain filtering module for implementing discrete cosine transform-domain filtering to the block of the video, wherein an encoding video using the filtering results. Implementing matrix multiplication further comprises calculating a prediction matrix using a training data set and recursively re-calculating the prediction matrix using a previous prediction matrix and prediction data of a current macroblock using neighboring pixels. The training data set is an offline training data set. The prediction matrix is computed using a cross-correlation matrix and an auto-correlation matrix. The filtering is applied to video coding. The coding comprises intra coding. The system further comprises implementing spatial filtering. Spatial filtering comprises restricting allowable values of the prediction matrix. A filter is restricted to have a unity DC gain, and/or a linear phase response. The filter is shift-invariant, and coefficients are chosen so that the L₂-norm prediction residual is minimized based on past statistics. Filtering is not implemented if the neighboring pixels are across an edge. The system further comprises implementing Discrete Cosine Transform-domain filtering. Implementing Discrete Cosine Transform-domain filtering comprises taking a discrete cosine transform of a block using a set of predictors resulting in transform coefficients, applying a weighting to the transform coefficients and taking an inverse discrete cosine transform to generate new predictors. The system further comprises taking the discrete cosine transform of neighboring pixels of the block for prediction. The system further comprises taking the discrete cosine transform utilizes a line of pixels from an above neighboring block and a same line of pixels from a left neighboring block. Applying the weighting includes weighting factors initially derived from offline training and updating based on previous reconstructed pixels. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray® writer/player, a television and a home entertainment system.

In another aspect, a camera device comprises an image acquisition component for acquiring an image, a processing component for processing the image by calculating a prediction matrix using a training data set and recursively re-calculating the prediction matrix using a previous prediction matrix and prediction data of a current macroblock using neighboring pixels to filter the image generating in a processed image and a memory for storing the processed image. The training data set is an offline training data set. The prediction matrix is computed using a cross-correlation matrix and an auto-correlation matrix. The filtering is applied to video coding. The coding comprises intra coding. The camera device further comprises implementing spatial filtering. Spatial filtering comprises restricting allowable values of the prediction matrix. A filter is restricted to have a unity DC gain, and/or a linear phase response. The filter is shift-invariant, and coefficients are chosen so that the L₂-norm prediction residual is minimized based on past statistics. Filtering is not implemented if the neighboring pixels are across an edge. The camera device further comprises implementing Discrete Cosine Transform-domain filtering. Implementing discrete cosine transform-domain filtering comprises taking a discrete cosine transform of a block using a set of predictors resulting in transform coefficients, applying a weighting to the transform coefficients and taking an inverse discrete cosine transform to generate new predictors. The camera device further comprises taking the discrete cosine transform of neighboring pixels of the block for prediction. The camera device further comprises taking the discrete cosine transform utilizes a line of pixels from an above neighboring block and a same line of pixels from a left neighboring block. Applying the weighting includes weighting factors initially derived from offline training and updating based on previous reconstructed pixels.

In yet another aspect, an encoder comprises an intra coding module for encoding an image for calculating a prediction matrix using a training data set and recursively re-calculating the prediction matrix using a previous prediction matrix and prediction data of a current macroblock using neighboring pixels to filter an image generating in a processed image and an intercoding module for encoding the image using motion compensation. The training data set is an offline training data set. The prediction matrix is computed using a cross-correlation matrix and an auto-correlation matrix. The filtering is applied to video coding. The coding comprises intra coding. The encoder further comprises implementing spatial filtering. Spatial filtering comprises restricting allowable values of the prediction matrix. A filter is restricted to have a unity DC gain, and/or a linear phase response. The filter is shift-invariant, and coefficients are chosen so that the L₂-norm prediction residual is minimized based on past statistics. Filtering is not implemented if the neighboring pixels are across an edge. The encoder further comprises implementing Discrete Cosine Transform-domain filtering. Implementing discrete cosine transform-domain filtering comprises taking a discrete cosine transform of a block using a set of predictors resulting in transform coefficients, applying a weighting to the transform coefficients and taking an inverse discrete cosine transform to generate new predictors. The encoder further comprises taking the discrete cosine transform of neighboring pixels of the block for prediction. The encoder further comprises taking the discrete cosine transform utilizes a line of pixels from an above neighboring block and a same line of pixels from a left neighboring block. Applying the weighting includes weighting factors initially derived from offline training and updating based on previous reconstructed pixels.

### BRIEF DESCRIPTION OF THE DRAWINGS

FIG. 1 illustrates a flowchart of implementing RAIS using matrix multiplication according to some embodiments.

FIG. 2A illustrates a diagram of a constraint of shift invariance.

FIG. 2B illustrates a diagram of an example of spatial filtering.

FIG. 3 illustrates a flow diagram implementing DCT-domain filtering according to some embodiments.

FIG. 4 illustrates a diagram of multiple filters within a block according to some embodiments.

FIG. 5 illustrates a variation of the DCT-domain filtering according to some embodiments.

FIG. 6 illustrates a variation of the DCT-domain filtering according to some embodiments.

FIG. 7 illustrates a block diagram of an exemplary computing device configured to implement recursive adaptive intra smoothing filters for intra-mode video coding according to some embodiments.

FIG. 8 illustrates a block diagram of a video coding layer according to some embodiments.

### DETAILED DESCRIPTION OF THE PREFERRED EMBODIMENT

A recursive adaptive intra smoothing (RAIS) filter for intra-mode video coding is described herein. The filter is able to be executed using one or more approaches including, but not limited to matrix multiplication, spatial filtering and frequency domain filtering. Matrix multiplication includes initially computing a prediction matrix Pₘ using offline training data. After coding a macroblock, Pₘ is updated for future macroblocks. In the case of applying spatial filtering, the shift invariance problem is reduced by imposing certain constraints on the matrix to be solved. In frequency domain filtering, a transform residual is minimized using DCT-domain filtering.

In inter-frame Recursive Adaptive Interpolation Filter (RAIF), for example, as described in U.S. Patent Application Ser. No. 61/301,430 , filed Feb. 4, 2011 and entitled, “RECURSIVE ADAPTIVE INTERPOLATION FILTERS (RAIF),” which is hereby incorporated by reference in its entirety for all purposes, if a current block of an image is y, then its motion compensated prediction is x. A set of filters Aₖ are tested, and the one that minimizes the prediction residual, ∥y−Aₖx∥₁, is chosen. The filter index k is then transmitted. Both the encoder and decoder update Rₓₓ (auto-correlation) and R_{xy} (cross-correlation) for the k^{th} filter, and use the new filter for the future blocks.

Recursive Adaptive Intra Smoothing (RAIS) using Matrix Multiplication

The inter prediction RAIF is extended to intra prediction which is referred to as RAIS. A 4×4 block intra prediction is used as an example. In RAIS, y is the current block being predicted which is vectorized to 16×1, and x is the L-shape neighbors, a 13×1 vector for a 4×4. For each intra prediction mode m (e.g. m could be one of the 9 modes defined in AVC), a prediction matrix Pₘ is employed: Pred(y)=Pₘx, where the size of Pₘ is 16×13 for prediction of 4×4. Thus, y is able to be predicted using x. The prediction matrix Pₘ is the optimal prediction matrix based on x and y. The Pₘ is determined by recursively letting the encoder and decoder learn about the statistics related to the predictor and the signal to be predicted. The previous statistics are used to improve the prediction during the encoding process. For each mode, there is a auto-correlation matrix Rₓₓ and an cross-correlation matrix R_{xy}. Initially, the cross-correlation matrix, the auto-correlation matrix and Pₘ are computed based on training data. After each macroblock is coded, Rₓₓ, R_{xy} and Pₘ are updated for future macroblocks by taking the previous values and combining them with new values including neighboring pixel prediction values. The update of the prediction matrix of the n^{th} macroblock is shown as follows:

Rₓₓ^{m}(n+1)=(1−λ)Rₓₓ^{m}(n)+λE(\hat{x}\hat{x}^{T})

R_{xy}^{m}(n+1)=(1−λ)R_{xy}^{m}(n)+λE(\hat{x}\hat{x}^{T})

Pₘ(n)[Rₓₓ^{m}(n)]⁻¹R_{xy}^{m}(n)

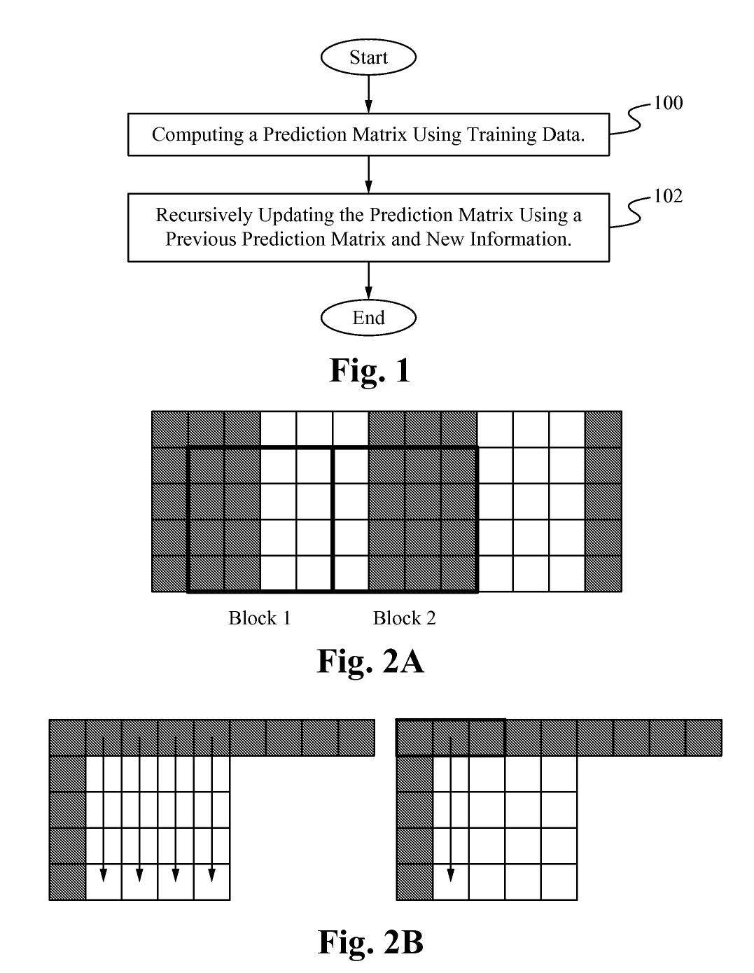

FIG. 1 illustrates a flowchart of implementing RAIS using matrix multiplication according to some embodiments. In the step 100, a prediction matrix Pₘ is computed using only training data. In the step 102, the prediction matrix is updated recursively using the previous prediction matrix Pₘ and new information. The new information includes prediction information for the current macroblock and neighboring pixels.

RAIS Using Spatial Filtering

RAIS using spatial filtering is a variation of the previous approach using matrix multiplication in the sense that certain constraints are imposed on the matrix to be solved. In spatial filtering, the constraint is shift invariance. One example is shown in FIG. 2A. A vertical pattern repeats itself over 3 columns of pixels. In matrix RAIS, the statistics (Rₓₓ and R_{xy}) of block 1 are expected to be similar to block 2; however, this is not the case, since the edge is found between pixels 2 and 3 in block 1 and between pixels 1 and 2 in block 2. In spatial filtering of RAIS, such disadvantage is able to be overcome since it is not sensitive to edge location. Spatial filtering is implemented by restricting the value of Pₘ(n) in the equation above. FIG. 2B illustrates an example. In this example, an intra smoothing filter is restricted to be a 3-tap filter, and the prediction mode is assumed to be VERTICAL. Without RAIS, each pixel is going to be predicted from the nearest top neighbor (left figure). With RAIS, the derived filter is first applied to the L-shape neighborhood, then VERTICAL prediction is performed (right figure). Therefore, each pixel is essentially predicted from 3 reconstructed pixels from the neighborhood. The condition that the filter is shift-invariant is further enforced, and the 3 coefficients are [a₋₁+a₀+a₁]. The 3 coefficients are chosen such that the L₂-norm prediction residual is minimized based on past statistics. Comparing to the matrix multiplication approach, where there are many unknowns to solve (e.g. 16×13 unknown elements in the matrix for 4×4 intra prediction), the intra smoothing filter has much fewer unknowns (in this example, there are only 3 unknowns), thus the complexity is reduced significantly. Further simplifications are possible, e.g. by enforcing the unity DC gain condition: a₋₁+a₀+a₁=1, and/or the symmetry condition (e.g. restricting the filters to be linear-phase): a₋₁=a₁. If both of them are enforced, there is only one unknown to solve.

Avoid Filtering Across an Edge

The derived RAIS filters usually have a low-pass characteristics. Therefore, filtering the neighborhood should be avoided if the corresponding pixels are across an edge. A 1D Laplacian operator [−1, 2, −1] is used to detect if there is a strong gradient at each neighborhood pixel. If the gradient is greater than a threshold, RAIS is not applied to that pixel to preserve the edge, and the auto- and cross-correlation matrices are not updated based on that pixel as well.

DCT-Domain Filtering

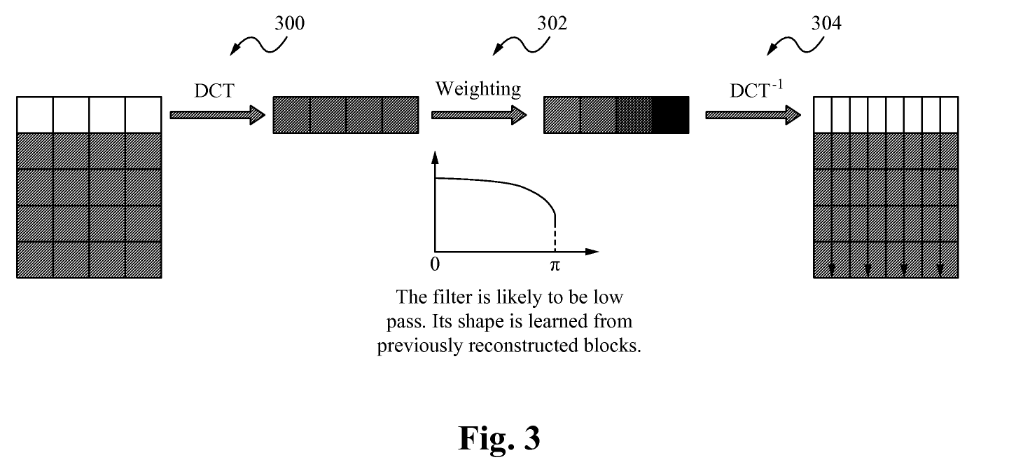

FIG. 3 illustrates a flow diagram implementing DCT-domain filtering for, but not limited to, VERTICAL intra prediction according to some embodiments. The top four pixels are used to predict the 4×4 block underneath the pixels. In the step 300, a DCT is taken of a block using the predictors, which results in transform coefficients. In the step 302, a weighting is applied to the transform coefficients which produces weighted transform coefficients. The weighting is learned from previously reconstructed blocks. For example, optimal weighting factors are applied to the cross-correlation and auto-correlation matrices from previous blocks and then the learned statistics are applied to the current block. Unlike spatial-domain filtering, where multiple filter coefficients have to be optimized together, DCT-domain weighting has the advantage that each frequency band is able to optimize its weight independently. Therefore, the auto correlation matrix becomes an diagonal matrix, which simplifies the matrix inversion operation significantly. In the step 304, an inverse DCT is taken to generate new predictors. The new predictors are similar to a low-pass version of the original predictors.

Using Different Filters within a Block

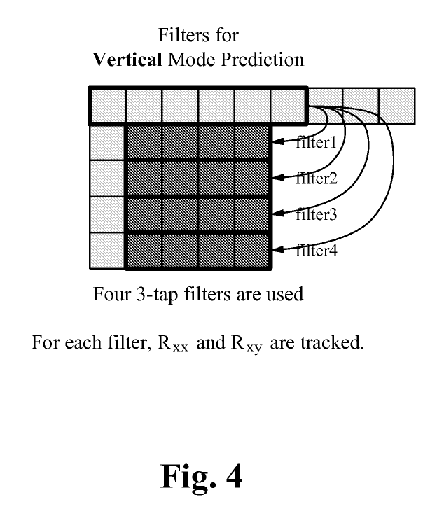

FIG. 4 illustrates a diagram of multiple filters within a block according to some embodiments. For example, for vertical prediction, a first filter is used for a first line of the block, a second filter is used for the second line of the block and so on. For each filter, Rₓₓ and R_{xy} are tracked separately. Thus, for four different filters, four different sets of Rₓₓ and R_{xy} are stored. In some embodiments, the filters used increase in strength while the distance between the pixels and the predictors grows. For example, a weaker low-pass filter is used for pixels close to the predictors, and a stronger low-pass filter is used for pixels further away from the predictors.

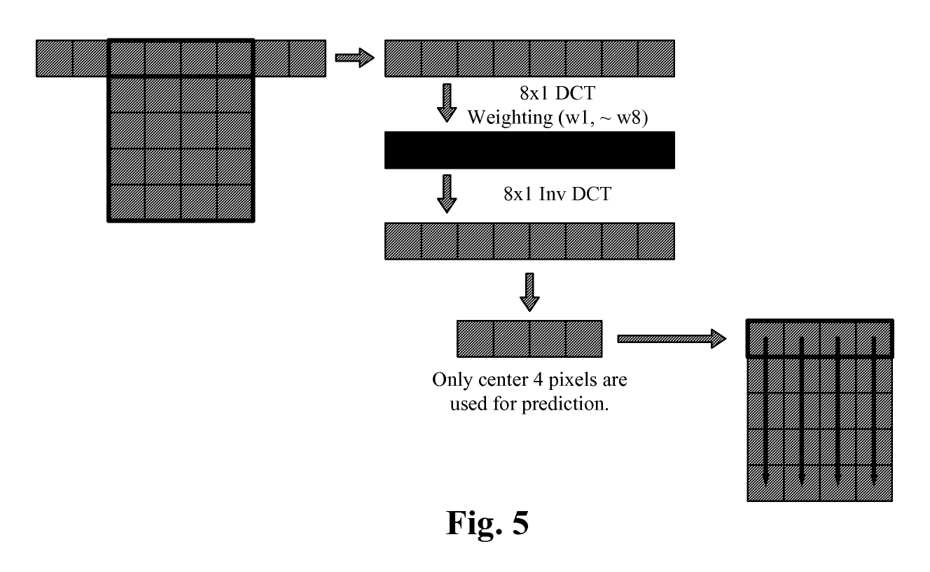

FIG. 5 illustrates a variation of the DCT-domain filtering according to some embodiments. In the variation, the DCT is applied to neighboring pixels, for example, two neighboring pixels on each side of the pixels being used for the prediction. This is able to increase the effectiveness of the predictions.

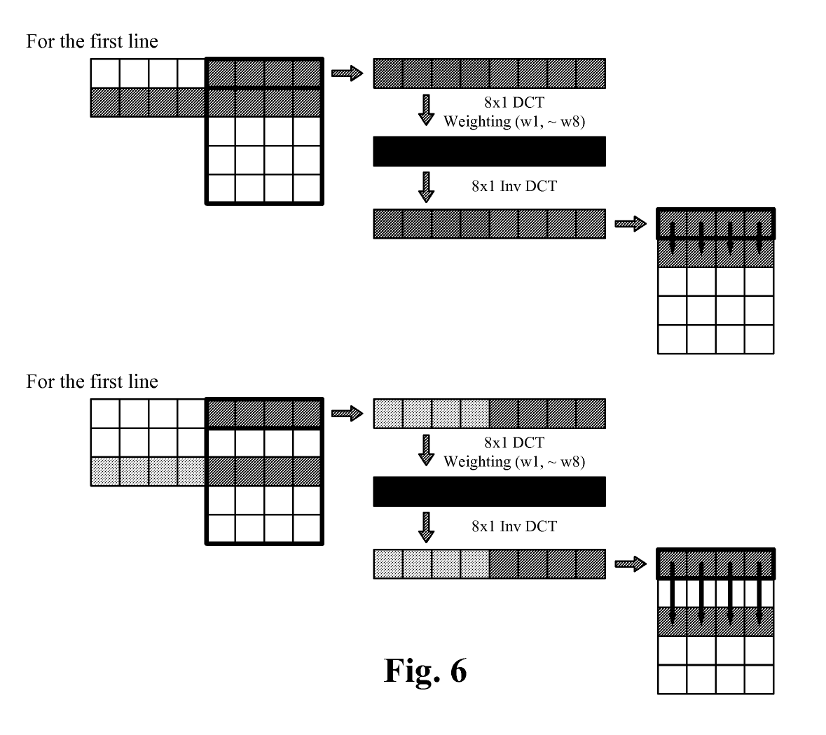

FIG. 6 illustrates a variation of the DCT-domain filtering according to some embodiments. In the variation, the same line of the left neighboring block and a neighboring line of a top neighboring block are combined, and then a DCT weighting is applied to generate predictors of the current block.

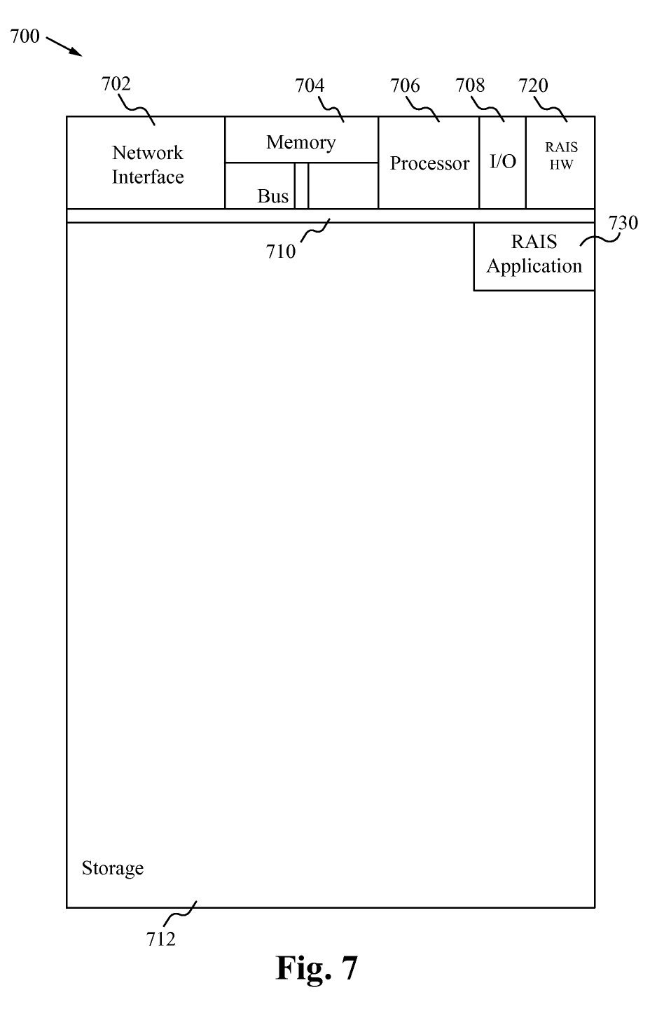

FIG. 7 illustrates a block diagram of an exemplary computing device 700 configured to implement recursive adaptive intra smoothing filters for intra-mode video coding according to some embodiments. The computing device 700 is able to be used to process information such as images and videos. For example, a computing device 700 is able to encode video using recursive adaptive intra-smoothing filters. In general, a hardware structure suitable for implementing the computing device 700 includes a network interface 702, a memory 704, a processor 706, I/O device(s) 708, a bus 710 and a storage device 712. The choice of processor is not critical as long as a suitable processor with sufficient speed is chosen. The memory 704 is able to be any conventional computer memory known in the art. The storage device 712 is able to include a hard drive, CDROM, CDRW, DVD, DVDRW, Blu-ray disc™, flash memory card or any other storage device. The computing device 700 is able to include one or more network interfaces 702. An example of a network interface includes a network card connected to an Ethernet or other type of LAN. The I/O device(s) 708 are able to include one or more of the following: keyboard, mouse, monitor, display, printer, modem, touchscreen, button interface and other devices. Recursive adaptive intra-smoothing application(s) 730 used to perform the recursive adaptive intra-smoothing are likely to be stored in the storage device 712 and memory 704 and processed as applications are typically processed. More or less components than shown in FIG. 7 are able to be included in the computing device 700. In some embodiments, recursive adaptive intra-smoothing hardware 720 is included. Although the computing device 700 in FIG. 7 includes applications 730 and hardware 720 for implementing recursive adaptive intra-smoothing, the recursive adaptive intra-smoothing is able to be implemented on a computing device in hardware, firmware, software or any combination thereof.

In some embodiments, the recursive adaptive intra-smoothing application(s) 730 include several applications and/or modules. In some embodiments, the recursive adaptive intra-smoothing application(s) 730 include modules such as a matrix multiplication module for implementing RAIS using matrix multiplication, a spatial filtering module for implementing spatial filtering and a DCT-domain filtering module for implementing DCT-domain filtering. In some embodiments, fewer or additional modules and/or sub-modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone, a video player, a DVD writer/player, a Blu-Ray® writer/player, a television, a home entertainment system or any other suitable computing device.

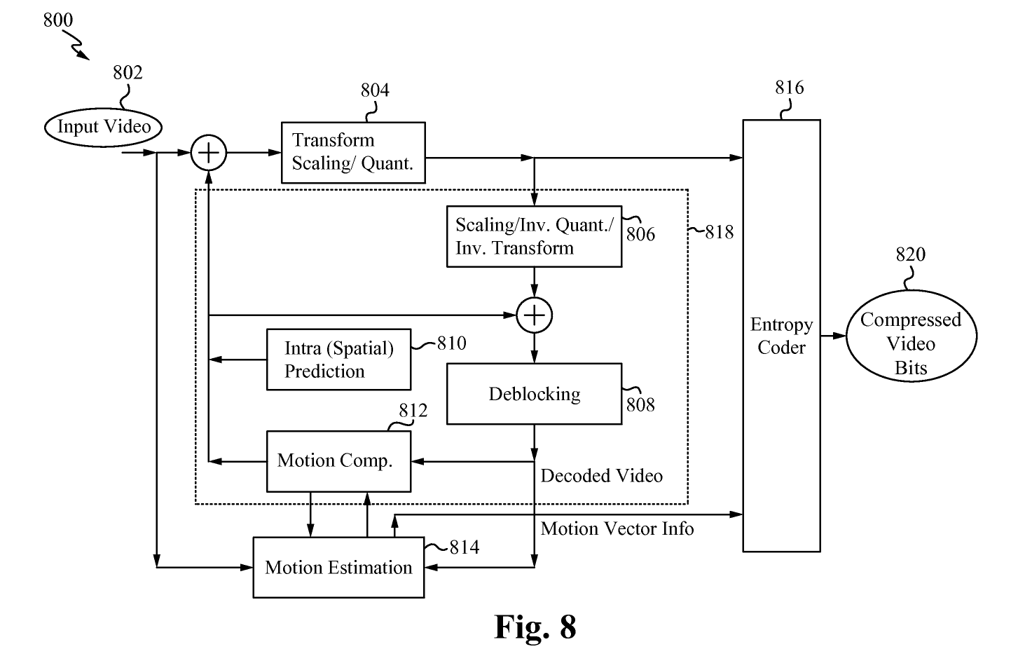

FIG. 8 illustrates a block diagram of a video coding layer 800 of a macroblock. The video coding layer 800 (e.g. the encoder) includes a combination of temporal and spatial predictions along with transform coding. An input video 802 is received and split into a plurality of blocks. The first picture of a sequence is usually “intra” coded using only information contained within itself. Each part of a block in an intra frame is then predicted at the intra prediction module 810 using spatially neighboring samples of previously coded blocks. The encoding process chooses which neighboring samples are utilized for intra prediction and how they are used. In some embodiments, “intra” coding includes one or more embodiments of the recursive adaptive intra-smoothing methods described herein. This process is conducted at the local decoder 818 as well as at the encoder 800. For the rest of the pictures of a sequence, usually “inter” coding is used. Inter coding implements motion compensation 812 from other previously decoded pictures. The encoding process for inter prediction/motion estimation at the motion estimation module 814 includes choosing motion data, determining the reference picture and a spatial displacement that is applied to all samples of the block. The motion data is transmitted as side information which is used by the encoder 800 and the local decoder 818.

The difference between the original and the predicted block is referred to as the residual of the prediction. The residual is transformed, and the transform coefficients are scaled and quantized at the transform and scaling quantization module 804. Each block is transformed using an integer transform, and the transform coefficients are quantized and transmitted using entropy-coding methods. An entropy encoder 816 uses a codeword set for all elements except the quantized transform coefficients. For the quantized transform coefficients, Context Adaptive Variable Length Coding (CAVLC) or Context Adaptive Binary Arithmetic Coding (CABAC) is utilized. The deblocking filter 808 is implemented to control the strength of the filtering to reduce the blockiness of the image.

The encoder 800 also contains the local decoder 818 to generate prediction reference for the next blocks. The quantized transform coefficients are inverse scaled and inverse transformed 806 in the same way as the encoder side which gives a decoded prediction residual. The decoded prediction residual is added to the prediction, and the combination is directed to the deblocking filter 808 which provides decoded video as output. Ultimately, the entropy coder 816 produces compressed video bits 820 of the originally input video 802.

To utilize recursive adaptive intra-smoothing, a device such as a digital camera or camcorder is used to acquire an image or video of the scene. The recursive adaptive intra-smoothing is automatically performed. The recursive adaptive intra-smoothing is also able to be implemented after the image is acquired to perform post-acquisition processing.

In operation, recursive adaptive intra-smoothing is for block-based transforms. The compression method involves one or more of matrix multiplication, spatial filtering and frequency domain filtering. By implementing recursive adaptive intra-smoothing, compression efficiency is improved.

### Some Embodiments of Recursive Adaptive Intra Smoothing for Intra-Mode Video Coding

1. A method of filtering a video programmed in a memory in a device comprising:
   a. calculating a prediction matrix using a training data set; and
   b. recursively re-calculating the prediction matrix using a previous prediction matrix and prediction data of a current macroblock using neighboring pixels.
2. The method of clause 1 wherein the training data set is an offline training data set.
3. The method of clause 1 wherein the prediction matrix is computed using a cross-correlation matrix and an auto-correlation matrix.
4. The method of clause 1 wherein the filtering is applied to video coding.
5. The method of clause 1 wherein the coding comprises intra coding.
6. The method of clause 1 further comprising implementing spatial filtering.
7. The method of clause 6 wherein spatial filtering comprises restricting allowable values of the prediction matrix.
8. The method of clause 7 wherein a filter is restricted to have a unity DC gain, and/or a linear phase response.
9. The method of clause 8 wherein the filter is shift-invariant, and coefficients are chosen so that the L₂-norm prediction residual is minimized based on past statistics.
10. The method of clause 6 wherein filtering is not implemented if the neighboring pixels are across an edge.
11. The method of clause 1 further comprising implementing Discrete Cosine Transform-domain filtering.
12. The method of clause 11 wherein implementing discrete cosine transform-domain filtering comprises:
   a. taking a discrete cosine transform of a block using a set of predictors resulting in transform coefficients;
   b. applying a weighting to the transform coefficients; and
   c. taking an inverse discrete cosine transform to generate new predictors.
13. The method of clause 12 further comprising taking the discrete cosine transform of neighboring pixels of the block for prediction.
14. The method of clause 12 further comprising taking the discrete cosine transform utilizes a line of pixels from an above neighboring block and a same line of pixels from a left neighboring block.
15. The method of clause 12 wherein applying the weighting includes weighting factors initially derived from offline training and updating based on previous reconstructed pixels.
16. The method of clause 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray® writer/player, a television and a home entertainment system.
17. A method of filtering a video programmed in a memory in a device comprising:
   a. implementing a first filter for filtering a first row/column of a block of the video; and
   b. implementing one or more additional filters for filtering additional rows/columns of the block of the video.
18. The method of clause 17 wherein the first row/column is nearest to predictor pixels and the additional rows/columns are further from the predictor pixels.
19. The method of clause 17 wherein the first filter is weaker than the one or more additional filters.
20. The method of clause 19 wherein the one or more additional filters are each as strong or are progressively stronger in low-pass as a distance from predictor pixels increases.
21. The method of clause 17 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray® writer/player, a television and a home entertainment system.
22. A system for filtering a video programmed in a memory in a device comprising:
   a. a matrix multiplication module for implementing matrix multiplication on a block of the video;
   b. a spatial filtering module for applying spatial filtering to the matrix multiplication; and
   c. a discrete cosine transform-domain filtering module for implementing discrete cosine transform-domain filtering to the block of the video, wherein an encoding video using the filtering results.
23. The system of clause 20 wherein implementing matrix multiplication further comprises:
   a. calculating a prediction matrix using a training data set; and
   b. recursively re-calculating the prediction matrix using a previous prediction matrix and prediction data of a current macroblock using neighboring pixels.
24. The system of clause 23 wherein the training data set is an offline training data set.
25. The system of clause 23 wherein the prediction matrix is computed using a cross-correlation matrix and an auto-correlation matrix.
26. The system of clause 23 wherein the filtering is applied to video coding.
27. The system of clause 23 wherein the coding comprises intra coding.
28. The system of clause 23 further comprising implementing spatial filtering.
29. The system of clause 28 wherein spatial filtering comprises restricting allowable values of the prediction matrix.
30. The system of clause 29 wherein a filter is restricted to have a unity DC gain, and/or a linear phase response.
31. The system of clause 30 wherein the filter is shift-invariant, and coefficients are chosen so that the L₂-norm prediction residual is minimized based on past statistics.
32. The system of clause 28 wherein filtering is not implemented if the neighboring pixels are across an edge.
33. The system of clause 23 further comprising implementing Discrete Cosine Transform-domain filtering.
34. The system of clause 33 wherein implementing Discrete Cosine Transform-domain filtering comprises:
   a. taking a discrete cosine transform of a block using a set of predictors resulting in transform coefficients;
   b. applying a weighting to the transform coefficients; and
   c. taking an inverse discrete cosine transform to generate new predictors.
35. The system of clause 34 further comprising taking the discrete cosine transform of neighboring pixels of the block for prediction.
36. The system of clause 34 further comprising taking the discrete cosine transform utilizes a line of pixels from an above neighboring block and a same line of pixels from a left neighboring block.
37. The system of clause 34 wherein applying the weighting includes weighting factors initially derived from offline training and updating based on previous reconstructed pixels.
38. The system of clause 23 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray® writer/player, a television and a home entertainment system.
39. A camera device comprising:
   a. an image acquisition component for acquiring an image;
   b. a processing component for processing the image by:
      i. calculating a prediction matrix using a training data set; and
      ii. recursively re-calculating the prediction matrix using a previous prediction matrix and prediction data of a current macroblock using neighboring pixels to filter the image generating in a processed image; and
   c. a memory for storing the processed image.
40. The camera device of clause 39 wherein the training data set is an offline training data set.
41. The camera device of clause 39 wherein the prediction matrix is computed using a cross-correlation matrix and an auto-correlation matrix.
42. The camera device of clause 39 wherein the filtering is applied to video coding.
43. The camera device of clause 39 wherein the coding comprises intra coding.
44. The camera device of clause 39 further comprising implementing spatial filtering.
45. The camera device of clause 44 wherein spatial filtering comprises restricting allowable values of the prediction matrix.
46. The camera device of clause 45 wherein a filter is restricted to have a unity DC gain, and/or a linear phase response.
47. The camera device of clause 46 wherein the filter is shift-invariant, and coefficients are chosen so that the L₂-norm prediction residual is minimized based on past statistics.
48. The camera device of clause 44 wherein filtering is not implemented if the neighboring pixels are across an edge.
49. The camera device of clause 39 further comprising implementing Discrete Cosine Transform-domain filtering.
50. The camera device of clause 49 wherein implementing discrete cosine transform-domain filtering comprises:
   a. taking a discrete cosine transform of a block using a set of predictors resulting in transform coefficients;
   b. applying a weighting to the transform coefficients; and
   c. taking an inverse discrete cosine transform to generate new predictors.
51. The camera device of clause 50 further comprising taking the discrete cosine transform of neighboring pixels of the block for prediction.
52. The camera device of clause 50 further comprising taking the discrete cosine transform utilizes a line of pixels from an above neighboring block and a same line of pixels from a left neighboring block.
53. The camera device of clause 50 wherein applying the weighting includes weighting factors initially derived from offline training and updating based on previous reconstructed pixels.
54. An encoder comprising:
   a. an intra coding module for encoding an image for:
      i. calculating a prediction matrix using a training data set; and
      ii. recursively re-calculating the prediction matrix using a previous prediction matrix and prediction data of a current macroblock using neighboring pixels to filter an image generating in a processed image; and
   b. an intercoding module for encoding the image using motion compensation.
55. The encoder of clause 54 wherein the training data set is an offline training data set.
56. The encoder of clause 54 wherein the prediction matrix is computed using a cross-correlation matrix and an auto-correlation matrix.
57. The encoder of clause 54 wherein the filtering is applied to video coding.
58. The encoder of clause 54 wherein the coding comprises intra coding.
59. The encoder of clause 54 further comprising implementing spatial filtering.
60. The encoder of clause 59 wherein spatial filtering comprises restricting allowable values of the prediction matrix.
61. The encoder of clause 60 wherein a filter is restricted to have a unity DC gain, and/or a linear phase response.
62. The encoder of clause 61 wherein the filter is shift-invariant, and coefficients are chosen so that the L₂-norm prediction residual is minimized based on past statistics.
63. The encoder of clause 59 wherein filtering is not implemented if the neighboring pixels are across an edge.
64. The encoder of clause 54 further comprising implementing Discrete Cosine Transform-domain filtering.
65. The encoder of clause 64 wherein implementing discrete cosine transform-domain filtering comprises:
   a. taking a discrete cosine transform of a block using a set of predictors resulting in transform coefficients;
   b. applying a weighting to the transform coefficients; and
   c. taking an inverse discrete cosine transform to generate new predictors.
66. The encoder of clause 65 further comprising taking the discrete cosine transform of neighboring pixels of the block for prediction.
67. The encoder of clause 65 further comprising taking the discrete cosine transform utilizes a line of pixels from an above neighboring block and a same line of pixels from a left neighboring block.
68. The encoder of clause 65 wherein applying the weighting includes weighting factors initially derived from offline training and updating based on previous reconstructed pixels.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of filtering a video programmed in a memory in a device comprising:
a. calculating a prediction matrix using a training data set; and
b. recursively re-calculating the prediction matrix using a previous prediction matrix and prediction data of a current macroblock using neighboring pixels.

2. The method of claim 1 wherein the training data set is an offline training data set.

3. The method of claim 1 wherein the prediction matrix is computed using a cross-correlation matrix and an auto-correlation matrix.

4. The method of claim 1 wherein the filtering is applied to video coding.

5. The method of claim 1 wherein the coding comprises intra coding.

6. The method of claim 1 further comprising implementing spatial filtering.

7. The method of claim 6 wherein spatial filtering comprises restricting allowable values of the prediction matrix.

8. The method of claim 7 wherein a filter is restricted to have a unity DC gain, and/or a linear phase response.

9. The method of claim 8 wherein the filter is shift-invariant, and coefficients are chosen so that the L₂-norm prediction residual is minimized based on past statistics.

10. The method of claim 6 wherein filtering is not implemented if the neighboring pixels are across an edge.

11. The method of claim 1 further comprising implementing Discrete Cosine Transform-domain filtering.

12. The method of claim 11 wherein implementing discrete cosine transform-domain filtering comprises:
a. taking a discrete cosine transform of a block using a set of predictors resulting in transform coefficients;
b. applying a weighting to the transform coefficients; and
c. taking an inverse discrete cosine transform to generate new predictors.

13. The method of claim 12 further comprising taking the discrete cosine transform of neighboring pixels of the block for prediction.

14. The method of claim 12 further comprising taking the discrete cosine transform utilizes a line of pixels from an above neighboring block and a same line of pixels from a left neighboring block.

15. The method of claim 12 wherein applying the weighting includes weighting factors initially derived from offline training and updating based on previous reconstructed pixels.

16. The method of claim 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray® writer/player, a television and a home entertainment system.

17. A method of filtering a video programmed in a memory in a device comprising:
a. implementing a first filter for filtering a first row/column of a block of the video; and
b. implementing one or more additional filters for filtering additional rows/columns of the block of the video.

18. The method of claim 17 wherein the first row/column is nearest to predictor pixels and the additional rows/columns are further from the predictor pixels.

19. The method of claim 17 wherein the first filter is weaker than the one or more additional filters.

20. The method of claim 19 wherein the one or more additional filters are each as strong or are progressively stronger in low-pass as a distance from predictor pixels increases.

21. The method of claim 17 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray® writer/player, a television and a home entertainment system.

22. A system for filtering a video programmed in a memory in a device comprising:
a. a matrix multiplication module for implementing matrix multiplication on a block of the video;
b. a spatial filtering module for applying spatial filtering to the matrix multiplication; and
c. a discrete cosine transform-domain filtering module for implementing discrete cosine transform-domain filtering to the block of the video, wherein an encoding video using the filtering results.

23. The system of claim 20 wherein implementing matrix multiplication further comprises:
a. calculating a prediction matrix using a training data set; and
b. recursively re-calculating the prediction matrix using a previous prediction matrix and prediction data of a current macroblock using neighboring pixels.

24. The system of claim 23 wherein the training data set is an offline training data set.

25. The system of claim 23 wherein the prediction matrix is computed using a cross-correlation matrix and an auto-correlation matrix.

26. The system of claim 23 wherein the filtering is applied to video coding.

27. The system of claim 23 wherein the coding comprises intra coding.

28. The system of claim 23 further comprising implementing spatial filtering.

29. The system of claim 28 wherein spatial filtering comprises restricting allowable values of the prediction matrix.

30. The system of claim 29 wherein a filter is restricted to have a unity DC gain, and/or a linear phase response.

31. The system of claim 30 wherein the filter is shift-invariant, and coefficients are chosen so that the L₂-norm prediction residual is minimized based on past statistics.

32. The system of claim 28 wherein filtering is not implemented if the neighboring pixels are across an edge.

33. The system of claim 23 further comprising implementing Discrete Cosine Transform-domain filtering.

34. The system of claim 33 wherein implementing Discrete Cosine Transform-domain filtering comprises:
a. taking a discrete cosine transform of a block using a set of predictors resulting in transform coefficients;
b. applying a weighting to the transform coefficients; and
c. taking an inverse discrete cosine transform to generate new predictors.

35. The system of claim 34 further comprising taking the discrete cosine transform of neighboring pixels of the block for prediction.

36. The system of claim 34 further comprising taking the discrete cosine transform utilizes a line of pixels from an above neighboring block and a same line of pixels from a left neighboring block.

37. The system of claim 34 wherein applying the weighting includes weighting factors initially derived from offline training and updating based on previous reconstructed pixels.

38. The system of claim 23 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray® writer/player, a television and a home entertainment system.

39. A camera device comprising:
a. an image acquisition component for acquiring an image;
b. a processing component for processing the image by:
i. calculating a prediction matrix using a training data set; and
ii. recursively re-calculating the prediction matrix using a previous prediction matrix and prediction data of a current macroblock using neighboring pixels to filter the image generating in a processed image; and
c. a memory for storing the processed image.

40. The camera device of claim 39 wherein the training data set is an offline training data set.

41. The camera device of claim 39 wherein the prediction matrix is computed using a cross-correlation matrix and an auto-correlation matrix.

42. The camera device of claim 39 wherein the filtering is applied to video coding.

43. The camera device of claim 39 wherein the coding comprises intra coding.

44. The camera device of claim 39 further comprising implementing spatial filtering.

45. The camera device of claim 44 wherein spatial filtering comprises restricting allowable values of the prediction matrix.

46. The camera device of claim 45 wherein a filter is restricted to have a unity DC gain, and/or a linear phase response.

47. The camera device of claim 46 wherein the filter is shift-invariant, and coefficients are chosen so that the L₂-norm prediction residual is minimized based on past statistics.

48. The camera device of claim 44 wherein filtering is not implemented if the neighboring pixels are across an edge.

49. The camera device of claim 39 further comprising implementing Discrete Cosine Transform-domain filtering.

50. The camera device of claim 49 wherein implementing discrete cosine transform-domain filtering comprises:
a. taking a discrete cosine transform of a block using a set of predictors resulting in transform coefficients;
b. applying a weighting to the transform coefficients; and
c. taking an inverse discrete cosine transform to generate new predictors.

51. The camera device of claim 50 further comprising taking the discrete cosine transform of neighboring pixels of the block for prediction.

52. The camera device of claim 50 further comprising taking the discrete cosine transform utilizes a line of pixels from an above neighboring block and a same line of pixels from a left neighboring block.

53. The camera device of claim 50 wherein applying the weighting includes weighting factors initially derived from offline training and updating based on previous reconstructed pixels.

54. An encoder comprising:
a. an intra coding module for encoding an image for:
i. calculating a prediction matrix using a training data set; and
ii. recursively re-calculating the prediction matrix using a previous prediction matrix and prediction data of a current macroblock using neighboring pixels to filter an image generating in a processed image; and
b. an intercoding module for encoding the image using motion compensation.

55. The encoder of claim 54 wherein the training data set is an offline training data set.

56. The encoder of claim 54 wherein the prediction matrix is computed using a cross-correlation matrix and an auto-correlation matrix.

57. The encoder of claim 54 wherein the filtering is applied to video coding.

58. The encoder of claim 54 wherein the coding comprises intra coding.

59. The encoder of claim 54 further comprising implementing spatial filtering.

60. The encoder of claim 59 wherein spatial filtering comprises restricting allowable values of the prediction matrix.

61. The encoder of claim 60 wherein a filter is restricted to have a unity DC gain, and/or a linear phase response.

62. The encoder of claim 61 wherein the filter is shift-invariant, and coefficients are chosen so that the L₂-norm prediction residual is minimized based on past statistics.

63. The encoder of claim 59 wherein filtering is not implemented if the neighboring pixels are across an edge.

64. The encoder of claim 54 further comprising implementing Discrete Cosine Transform-domain filtering.

65. The encoder of claim 64 wherein implementing discrete cosine transform-domain filtering comprises:
a. taking a discrete cosine transform of a block using a set of predictors resulting in transform coefficients;
b. applying a weighting to the transform coefficients; and
c. taking an inverse discrete cosine transform to generate new predictors.

66. The encoder of claim 65 further comprising taking the discrete cosine transform of neighboring pixels of the block for prediction.

67. The encoder of claim 65 further comprising taking the discrete cosine transform utilizes a line of pixels from an above neighboring block and a same line of pixels from a left neighboring block.

68. The encoder of claim 65 wherein applying the weighting includes weighting factors initially derived from offline training and updating based on previous reconstructed pixels.
